(19) United States
(12) Patent Application Publication
(10) Pub. No.: US 2021/0184263 A1
(43) Pub. Date: Jun. 17, 2021

(54) RECHARGEABLE BATTERY WITH IONIC LIQUID ELECTROLYTE AND ELECTRODE PRESSURE

(71) Applicants: HYDRO-QUEBEC, Montreal (CA); Government of the United States of America, as Represented by the Secretary of the Army, Aberdeen Proving Ground, MD (US)

(72) Inventors: DONGQIANG LIU, Longueuil (CA); AMELIE FORAND, Boucherville (CA); CHISU KIM, Longueuil (CA); KARIM ZAGHIB, Longueuil (CA); JAN L. ALLEN, Aberdeen Proving Ground, MD (US); SAMUEL A. DELP, III, Aberdeen Proving Ground, MD (US); RICHARD T. JOW, Aberdeen Proving Ground, MD (US)

(21) Appl. No.: 17/184,436

(22) Filed: Feb. 24, 2021

Related U.S. Application Data
(63) Continuation-in-part of application No. PCT/US2019/048742, filed on Aug. 29, 2019.
(60) Provisional application No. 62/725,087, filed on Aug. 30, 2018.

(51) Int. Cl. H01M 10/0568; H01M 10/0569; H01M 10/44; H01M 10/0525; H01M 4/136; H01M 4/58; H01M 10/0567; H01M 4/139

(52) U.S. Cl. CPC H01M 10/0568; H01M 10/0569; H01M 10/44; H01M 10/0525; H01M 2004/027; H01M 4/58; H01M 10/0567; H01M 4/139; H01M 4/136

(57) ABSTRACT

The disclosure provides an alkali metal or alkaline earth metal rechargeable battery including an electrolyte including an ionic liquid and an alkali metal salt or alkaline earth metal salt. The battery also includes a negative electrode including a surface that contacts the electrolyte. The negative electrode also includes a negative electrode active material. The battery further includes a positive electrode including a surface that contacts the electrolyte. The positive electrode also includes a positive electrode active material. The battery also includes an electronically insulative separator between the positive electrode and the negative electrode and a casing surrounding the electrolyte, electrodes, and separator. The battery additionally includes a pressure application system that applies pressure to at least a portion of the electrode surfaces contacting the electrolyte.

### PRIORITY CLAIM

The present application claims priority under 35 U.S.C. § 120 as a continuation-in-part of PCT/US2019/048742, filed Aug. 29, 2019, titled “RECHARGEABLE BATTERY WITH IONIC LIQUID ELECTROLYTE AND ELECTRODE PRESSURE,” which claims priority under 35 U.S.C. § 119(e) to U.S. Provisional Patent Application Ser. No. 62/725,087, filed Aug. 30, 2018, both of which are incorporated by reference herein in their entireties.

### TECHNICAL FIELD

The disclosure relates to an alkali metal or alkaline earth metal rechargeable battery that uses an ionic liquid electrolyte to operate at high voltages. The battery also applies pressure to the electrodes.

### BACKGROUND

Many rechargeable batteries contain organic liquid electrolytes. Although organic liquid electrolytes are able to operate over a variety of voltages and have other advantages, a major disadvantage of organic liquid electrolytes is their tendency to catch fire, especially if the battery is damaged or has been charged and discharged many times. Another disadvantage of organic liquid electrolytes is their tendency to generate gasses during long term charge/discharge processes, especially when the charge voltage is 4.4 V or higher. The gas generation mostly results from electrolyte decomposition. The presence of gasses causes problems in batteries by interrupting the battery structure, often resulting in a decrease in battery capacity as the number of charge/discharge cycles increases (capacity fade) or failure of the battery to operate at all. Therefore, traditional carbonate organic liquid electrolytes are not suitable for batteries that operate at or above 4.4 V.

Compared with organic liquid electrolytes, ionic liquids are not combustible and have wider operating windows and, thus, are a safer alternative to organic liquid electrolytes for high voltage alkali metal or alkaline earth metal rechargeable batteries.

### SUMMARY

The present disclosure provides an alkali metal or alkaline earth metal rechargeable battery including an electrolyte including an ionic liquid and an alkali metal salt or alkaline earth metal salt. The battery also includes a negative electrode including a surface that contacts the electrolyte. The negative electrode also includes a negative electrode active material. The battery further includes a positive electrode including a surface that contacts the electrolyte. The positive electrode also includes a positive electrode active material. The battery also includes an electronically insulative separator between the positive electrode and the negative electrode and a casing surrounding the electrolyte, electrodes, and separator. The battery additionally includes a pressure application system that applies pressure to at least a portion of the electrode surfaces contacting the electrolyte.

The above battery may be further characterized by one or more of the following additional features, which may be combined with one another or any other portion of the description in this specification, including specific examples, unless clearly mutually exclusive:

i) the pressure application system may include a seal internal to the battery and a pressure application structure;

i-a) the pressure application structure may include plates and a clamp or screw;

i-b) the pressure application structure may include a pressure bladder;

ii) the battery may also include a gas relocation area;

iii) the battery may have an operating voltage of between and including 1 V and 8 V;

iv) the pressure application structure may apply pressure to at least 90% the surfaces of the electrodes contacting the electrolyte;

v) pressure applied by the pressure application structure may not vary by more than 5% between any points where the pressure is applied;

vi) the pressure applied by the pressure application structure may be between 50 psi and 90 psi;

vii) the pressure applied by the pressure application structure may be between 70 psi and 75 psi;

viii) the battery may exhibit a capacity fade of between 1% and 50% over 110 cycles at C/2 as compared to the capacity at the tenth cycle at C/2;

ix) the battery may exhibit a capacity fade of between 50% and 1% over 110 cycles at C/2 as compared to the capacity at the tenth cycle at C/2 as compared to an otherwise identical battery lacking a pressure application system;

x) the ionic liquid may include a nitrogen (N)-based cationic component of the ionic liquid;

x-a) the N-based cationic component of the ionic liquid may include an ammonium ionic liquid;

x-a-1) the ammonium ionic liquid may include N,N-diethyl-N-methyl-N-(2-methoxy ethyl) ammonium;

x-b) the N-based cationic component of the ionic liquid may include an imidazolium ionic liquid;

x-b-1) the imidazolium ionic liquid may include ethyl methyl imidazolium (EMIm), methyl propyl imidazolium, (PMIm), butyl methyl imidazolium (BMIm), or 1-ethyl-2,3-dimethylimidazolium, or any combinations thereof;

x-c) the N-based cationic component of the ionic liquid may include a piperidinium ionic liquid;

x-c-1) the piperidinium ionic liquid may include ethyl methyl piperidinium (EMPip), methyl propyl piperidinium (PMPip), or butyl methyl piperidinium (BMPip), or any combinations thereof.

x-d) the N-based cationic component of the ionic liquid may include a pyrrolidinium ionic liquid;

x-d-1) the pyrrolidinium ionic liquid may include ethyl methyl pyrrolidinium (EMPyr), methyl propyl pyrrolidinium (PMPyr), or butyl methyl pyrrolidinium (BMPyr), or any combinations thereof;

xi) the ionic liquid may include a phosphorus (P)-based cationic component of the ionic liquid;

xi-a) the P-based cationic component of the ionic liquid may include a phosphonium ionic liquid;

xi-a-1) the phosphonium ionic liquid includes PR₃R′ phosphonium, wherein R is methyl, ethyl butyl, hexyl, or cyclohexyl, and R′ is methyl or butyl ((CH₂)₃CH₃), or any combinations thereof;

xi-a-2) the ionic liquid containing a N-based cationic component or a P-based cationic component may also include an anionic component, which may include bis(fluorsulfonyl)imide (FSI), bis(trifluoromethanesulfonyl)imide (TFSI), and (bis(pentafluoroethanesulfonyl)imide) (BETI), tosylate, carboxylate, phosphinate, dialkylphosphate, alkylsulfate, tetrafluoroborate (BF₄) or hexaflurophosphate (PF₆)., or any combinations thereof;

xii) the alkali metal salt my include LiN(FSO₂)₂ (LiFSI), LiCF₃SO₃, LiN(CF₃SO₂)₂ (LiTFSI), LiN(CF₃CF₂SO₂)₂ (LiBETI), or NaBF₄, or any combinations thereof;

xiii) the negative electrode active material may include metal, carbon, a lithium or sodium titanate or niobiate, or a lithium or sodium alloy;

xiv) the positive electrode active material may include a lithium transition metal oxide, an alkali metal or alkaline earth metal-transition metal phosphate, sulfate, silicate, or vanadate, or alkali metal or alkaline earth metal-multi metal-oxides or phosphates, sulfates, silicates, or vanadates;

xv) the positive electrode active material may include an attritor-mixed active material having the general chemical formula AₓM_{y}E_{z}(XO₄)_{q} and a crystal structure, wherein A is an alkali metal or alkaline earth metal, M is an electrochemically active metal, E is located in the same structural location as A in the crystal structure and is a non-electrochemically active metal, a boron group element, or silicon (Si) or any alloys or combinations thereof, X is phosphorus (P) or sulfur (S) or a combination thereof, 0<x≤1, y>0, z≥0, q>0, and the relative values of x, y, z, and q are such that the general chemical formula is charge balanced;

xv-a) A may be lithium (Li) or sodium (Na);

xv-b-1) A may be Li;

xv-b-2) A may be Na.

xv-c) M may be a transition metal, or an alloy or any combinations thereof;

xv-c-1) M may be iron (Fe), chromium (Cr), manganese (Mn), nickel (Ni), cobalt (Co), vanadium (V), or titanium, or an alloy or any combinations thereof ;

xv-c-2) M may be Co or an alloy thereof;

xv-c-3) M may be a combination of Co and Fe;

xv-c-4) M may be a combination of Co and Cr;

xv-c-5) M may be a combination of Co, Fe, and Cr;

xv-d) wherein z may be greater than 0;

xv-d-1) E may be Si;

xv-d-2) E may be a non-electrochemically active metal.

xv-d-2-A) the non-electrochemically active metal may be magnesium (Mg), calcium (Ca) or strontium (Sr), zinc (Zn), scandium (Sc), or lanthanum (La), or any alloys or combinations thereof

xv-d-3) E may be a boron group element;

xv-d-3-A) the boron group element may be aluminum (Al) or gallium (Ga) or a combination thereof;

xv-e) X may be P.

xv-f) X may be S.

xv-g) X may be Si.

### BRIEF DESCRIPTION OF THE DRAWINGS

The patent or application file contains at least one drawing executed in color. Copies of this patent or patent application publication with color drawings will be provided by the Office upon request and payment of the necessary fee. Embodiments of the present disclosure may be further understood through reference to the attached figures, in which like numerals represent like features.

FIG. 1 is a schematic cross-sectional drawing of a battery according to the present disclosure.

FIG. 2 is a schematic drawing of a bottom portion of a battery according to the present disclosure.

FIG. 3 is a photograph of a side of a screw-pressure battery according to the present disclosure.

FIG. 4 is photograph of a side of an air-pressure battery according to the present disclosure.

FIG. 5 is an X-ray diffraction (XRD) profile of a multiple-substituted lithium cobalt phosphate (LiCo_{0.82}Fe_{0.0976}Cr_{0.0488}Si_{0.00976}PO₄) positive electrode active material. Typical XRD patterns of the final product with trace of impurity are marked by *.

FIG. 6 is a representative energy-dispersive X-ray spectroscopy (EDX) analysis of an iron (Fe), silicon (Si) and chromium (Cr)-containing positive electrode active material showing trace Si and Cr agglomeration. The scale bar in all images is 10 μm.

FIG. 7 is a representative cross-sectional energy-dispersive X-ray spectroscopy (EDX) analysis of a Fe, Cr and Si-containing positive electrode active material showing trace Cr impurities. The scale bar in the leftmost image is 10 μm. The scale bars in all other images is 5 μm.

FIG. 8A and FIG. 8B are a pair of representative scanning electron microscope (SEM) image of particles of positive electrode active material. The scale bar in FIG. 8A is 20 μm. The scale bar in FIG. 8B image is 5 μm.

FIG. 9 is a flow chart of a method of attritor-mixing precursors and heating to form an active material.

FIG. 10 is a schematic partially cross-sectional elevation drawing of an attritor suitable for use in the present disclosure.

FIG. 11 is a graph showing the effect of ball:precursor w:w ratio during attritor mixing on capacity of active material formed from the attritor-mixed precursors.

FIG. 12A is a graph showing particle size distribution after attritor-mixing for 6 hours with an 8:1 ball:precursor w:w ratio.

FIG. 12B is a graph showing the particle size distribution of the same precursor mixture as in FIG. 12A after attritor-mixing for 12 hours with an 8:1 ball:precursor w:w ratio.

FIG. 13 is a graph showing cycling stability of two batteries according to the present disclosure.

FIG. 14 is a graph showing cycling stability and coulombic efficiency of a battery according to the present disclosure.

FIG. 15 is a graph showing cycling stability of a battery according to the present disclosure.

FIG. 16 is a graph showing cycling stability of a comparative battery not according to the present disclosure.

FIG. 17 is another graph showing cycling stability of a battery according to the present disclosure.

FIG. 18 is a photograph of the battery according to the present disclosure used to obtain the data in FIG. 17.

FIG. 19 is another graph showing cycling stability of a comparative battery not according to the present disclosure.

FIG. 20 is a photograph of the comparative battery not according to the present disclosure used to obtain the data in FIG. 19.

FIG. 21 is an XRD profile of a LiCo_{0.82}Fe_{0.0976}Cr_{0.0488}Si_{0.00976}PO₄ active material after 6 hours or 12 hours of attritor-mixing with a 6:1 ball:precursor w:w ratio.

FIG. 22 is an XRD profile of a LiCo_{0.82}Fe_{0.0976}Cr_{0.0488}Si_{0.00976}PO₄ active material after 12 hours of attritor-mixing with an 8:1 ball:precursor w:w ratio.

FIG. 23 is an XRD profile of a LiCo_{0.82}Fe_{0.0976}Cr_{0.0488}Si_{0.00976}PO₄ active material after 12 hours of attritor-mixing a with a 10:1 ball:precursor w:w ratio.

FIG. 24 is an XRD profile of a LiCo_{0.82}Fe_{0.0976}Cr_{0.0488}Si_{0.00976}PO₄ active material after 12 hours of attritor-mixing a with a 12:1 ball:precursor w:w ratio.

FIG. 25 is an XRD profile of a LiCo_{0.82}Fe_{0.0976}Cr_{0.0488}Si_{0.00976}PO₄ active material after 12 hours of attritor-mixing a with a 14:1 ball:precursor w:w ratio.

25

### DETAILED DESCRIPTION

The disclosure relates to an alkali metal or alkaline earth metal rechargeable battery that uses an ionic liquid electrolyte to operate at high voltages and that also applies pressure to the electrodes.

Batteries according to the present disclosure may operate at any voltage, such as between 1.0 V and 8.0 V, but in particular, they may operate at a voltage of at least 4.0 V, at least 4.4 V, at least 4.5 V, at least 5.0 V, between and including 4.0 V and 5.0 V, between and including 4.0 V and 6.0V, between and including 4.0 V and 7.0 V, between and including 4.0 V and 8.0 V, between and including 4.4 V and 5.0 V, between and including 4.4 V and 6.0 V, between and including 4.4 V and 7.0 V, between and including 4.4 V and 8.0 V, between and including 4.5 V and 5.0 V, between and including 4.5 V and 6.0 V, between and including 4.5 V and 7.0 V, between and including 4.5 V and 8.0 V, between and including 5.0 V and 6.0 V, between and including 5.0 V and 7.0 V, between and including 5.0 V and 8.0 V.

Batteries according to the present disclosure apply a pressure to at least a portion of the surfaces of the electrodes contacting the electrolyte. This pressure is applied over 100% of the surfaces of the electrodes contacting the electrolyte, or over at least 90%, at least 95%, or at least 98% of the surfaces of the electrodes contacting the electrolyte. The pressure is sufficient to prevent or decrease the formation of gas in the battery, or to cause gas that is formed to move to an area of the battery not between the surfaces of the electrodes contacting the electrolyte. In particular, batteries according to the present disclosure may apply a pressure to the surfaces of the electrodes that is uniform and does not vary by more than 5% between any points where pressure is applied. The pressure may be at least 50 psi, at least 60 psi, at least 70 psi, at least 75 psi at least 80 psi, at least 90 psi, and any range between and including any of the foregoing (e.g. between and including 70 psi and 75 psi).

As a result of the pressure, batteries according to the present disclosure do not experience as much damage from gas formation and as much capacity fade as would be observed in a similar battery operated at the same voltage, but lacking a pressure application system. In particular, batteries of the present disclosure may experience a capacity fade of 50% or less, 40% or less, 20% or less, 10% or less, 5% or less, 1% or less, or a range between and including any combinations of these values over 110 cycles at C/2 as compared to the capacity at the tenth cycle at C/2. Alternatively or in addition, batteries of the present disclosure may experience a capacity fade of 50% less, 40% less, 20% less, 10% less, 5% less, 1% less, or a range between and including any combinations of these values over 110 cycles at C/2 as compared to the capacity at the tenth cycle at C/2 as compared to an otherwise identical battery lacking pressure application as described herein.

### Battery Structures

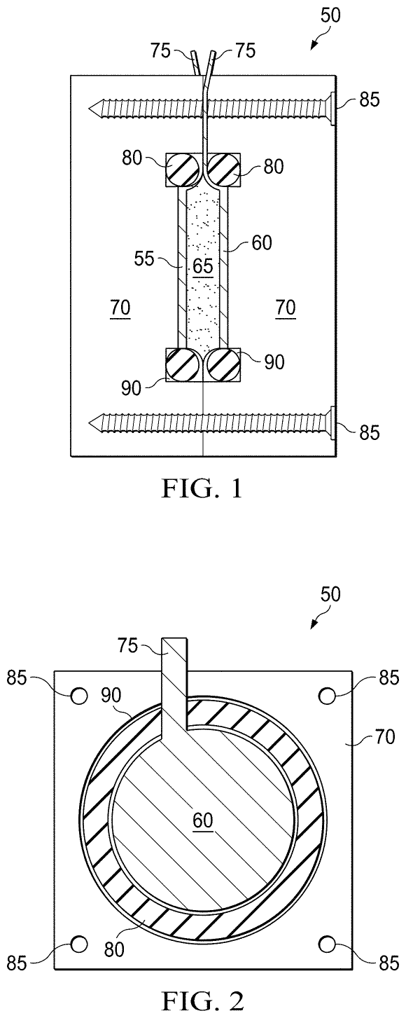

Referring now to FIGS. 1-4, an alkali metal or alkaline earth metal rechargeable battery 50 as described herein includes two electrodes, a negative electrode (anode) 55 and a positive electrode (cathode) 60 as well as an ionic liquid electrolyte 65. In addition, battery 50 includes a porous, electronically insulating separator (located in electrolyte 65) that permits ionic, but not electronic conductivity within the battery 50, a casing 70 sufficient to house and contain these internal components, and contacts 75 that, when connected via an electronically conductive connector, allow electric current to flow between the negative electrode 55 and the positive electrode 60.

The alkali metal or alkaline earth metal rechargeable battery 50 further includes a pressure application system that applies pressure to at least a portion of the surfaces of the electrodes 55 and 60 contacting the electrolyte 65. Pressure application systems may include internal seals along with a pressure application structure, such as plates (often the casing 70) and clamps, screws, pressure bladders, or other such structures that apply pressure to the plates or to the battery casing to maintain pressure within the battery. Pressure application systems may maintain pressure in a sealed portion of the battery, which likely inhibits the formation of gasses, but does not cause gasses to migrate once formed. Some batteries 50 may include a gas relocation area, to which the pressure application system tends to direct gasses once formed.

Seals, if present, may be formed from any material that is not reactive with the electrolyte, negative electrode, positive electrode, or other battery components it contacts. Although the some seal materials may exhibit some minimal reactivity, the material may be considered not reactive if its reactivity is sufficiently low to avoid seal failure, in an average battery having a given design, over a set number of cycles, such as at least 100 cycles, at least 200 cycles, at least 500 cycles, at least 2000 cycles, at least 5000 cycles, at least 10,000 cycles, or a range between and including any combinations of these values, when cycled at C/2.

In addition, some pressure application systems may apply pressure constantly once assembled. Other pressure application systems may be adaptable to apply pressure on at set times, such as shortly prior to or during operation of the battery or both.

Although FIGS. 1-4 provide some specific pressure application systems, one of ordinary skill in the art, using the teachings of this disclosure, may design other pressure application systems. In addition, although FIGS. 1-4 illustrate pressure application systems in use on a single pouch-type cell, a pressure application system may be used to apply pressure to multiple cells and cells of any format. Furthermore, although FIGS. 1-4 illustrate pressure applications systems in use on flat cells, they may be used on curved, bent, or other non-planar cell formats.

In FIGS. 1-3, the pressure application system includes ring seals 80 and screws 85. This type of pressure application system, as shown, seals a portion of the alkali metal or alkaline earth metal rechargeable battery 50 in which the electrodes 55 and 60 contact the electrolyte 65. The screws 85 apply pressure to the casing 70, which is in the form of rigid plates. The casing 70 transfers the pressure to the portion of the battery 50 inside the ring seals 80, which are located in a groove 90 such that there is pressure where the electrodes 55 and 60 contact the electrolyte 65 inside the ring seals 80.

Many alternatives to this example may be envisioned and also used. For instance, only a single seal may be used, the seal need not be located in a groove, the seal may have a shape other than a ring, and pressure applicators other than screws may be used.

In FIG. 4, the pressure application system includes air bladder 95, which may be inflated to a set pressure that is transferred to the casing 70. As depicted, this pressure application system does not contain any seals and will force and gasses that do form to gas relocation areas 100, particularly when pressure is newly applied to the casing 70. Accordingly, this pressure application system is particularly well-adapted to apply pressure shortly before or during battery use or both.

Many alternatives to this example may also be envisioned and used. For instance, air bladder 95 may be inflated with any other fluid, such as another gas or a liquid. The fluid in air bladder 95 may be selected, for example, to provide insulative or heat conduction properties.

Although not depicted, other batteries 50 of the present disclosure may attain a constant pressure on the electrodes 55 and 60 in contact with the electrolyte 65 simply by pressurizing the electrolyte 65 when it is added to the battery, then sealing the casing 70 in a manner that retains pressure.

### Battery Materials

The negative electrode (such as negative electrode 55) in an alkali metal or alkaline earth metal rechargeable battery of the present disclosure (such as battery 50) includes an active material. Suitable negative electrode active materials include lithium metal, carbon, such as graphite, lithium or sodium titanates or niobiates, and lithium or sodium alloys. The negative electrode may further include binders, conductive additives, and a current collector.

The electrolyte, such as electrolyte 65, in an alkali metal or alkaline earth metal rechargeable battery of the present disclosure, such as battery 50, includes an ionic liquid and an alkali metal salt with cation, typically a lithium ion (Li⁺) or a sodium ion (Na⁺) that also plates on or intercalates in the active material in the negative electrode or positive electrode or, more typically, both electrodes.

Ionic liquids include cationic components and anionic components.

Suitable ionic liquids include cationic components that may include nitrogen (N)-based ionic liquids. N-based ionic liquids include ammonium ionic liquids, such as N,N-diethyl-N-methyl-N-(2-methoxyethyl) ammonium. N-based ionic liquids include imidazolium ionic liquids, such as ethyl methyl imidazolium (EMIm), methyl propyl imidazolium, (PMIm), butyl methyl imidazolium (BMIm), and 1-ethyl-2,3-dimethylimidazolium. N-based ionic liquids further include piperidinium ionic liquids, such as ethyl methyl piperidinium (EMPip), methyl propyl piperidinium (PMPip), and butyl methyl piperidinium (BMPip). N-based ionic liquids additionally include pyrrolidinium ionic liquids, such as ethyl methyl pyrrolidinium (EMPyr), methyl propyl pyrrolidinium (PMPyr), butyl methyl pyrrolidinium (BMPyr).

Suitable cationic components of ionic liquids also include phosphorus (P)-based ionic liquids. P-based ionic liquids include phosphonium ionic liquids, such as PR₃R′ phosphonium, where R is methyl, ethyl, butyl, hexyl, or cyclohexyl, and R′ is methyl or butyl, or ((CH₂)₃CH₃).

Any cationic components of ionic liquids, in any of those described above, may be combined in any combinations in batteries of the present disclosure.

Anionic components of ionic liquids may include bis(trifluoromethanesulfonyl)imide (TFSI), and (bis(pentafluoroethanesulfonyl)imide) (BETI), tosylate, carboxylate, phosphinate, dialkylphosphate, alkylsulfate, and any combinations thereof. Anionic components of the ionic liquids may also include tetrafluoroborate (BF₄), hexaflurophosphate (PF₆), or a combination thereof. Examples of ionic liquids including cationic components and anionic components are 1-ethyl-3-methylimidazolium-bis(fluorsulfonyl)imide (EMI-FSI) and N-methyl-N-propylpyrrolidinium-bis(fluorsulfonyl)imide (Py13-FSI), trimethyl isobutyl phosphonium FSI, and tributyl(methyl)phosphonium tosylate.

The anion components of the ionic liquid include a phosphonium ionic liquid may include an anionic component that includes bis(fluorosulfonyl)imide (FSI), bis(trifluoromethanesulfonyl) imide (TFSI), bis(pentafluoroethanesulfonyl)imide (BETI), tetrafluoroborate (BF₄), tosylate, carboxylate, phosphinate, dialkylphosphate, alkylsulfate, and hexaflurophosphate (PF₆), or any combinations thereof.

Any anionic components of ionic liquids, in any of those described above, may be combined with cationic components of ionic liquids in any combinations in batteries of the present disclosure.

Suitable salts include alkali metal salts, such as lithium salts, such as alkali metal salt may include LiN(FSO₂)₂ (LiFSI), LiCF₃SO₃, LiN(CF₃SO₂)₂ (LiTFSI), LiN(CF₃CF₂SO₂)₂ (LiBETI), or any combinations thereof, particularly for lithium-ion batteries, or sodium salts, such as or NaBF₄, particularly for sodium-ion batteries. However, many salts increase the viscosity of the ionic liquid such that the electrolyte effectively loses ionic conductivity and the battery does not function well. This effect may increase as salt concentration increases. Some salts, such as the commonly used LiPF₆, simply will not function as an electrolyte in an ionic liquid.

The electrolyte may further include any of a number of co-solvents in any combinations. Suitable co-solvents include fluorinated carbonates (FEMC), fluorinated ethers, such as CF₃CH₂OCF₂CHF₂, nitriles, such as succinonitrile or adiponitrile, or sulfolane.

The electrolyte may also include any of a number of additives in any combinations. Suitable additives include tris(trimethylsilyl) phosphate (TMSP), tris(trimethylsilyl) phosphite (TMSPi), tris(trimethylsilyl) borate (TMSB), trimethylboroxine, trimethoxyboroxine, or propane sultone.

Suitable salts and concentrations for a given ionic liquid may be readily determined by one of ordinary skill in the art with the benefit of this disclosure. For example, a given concentration of a salt may be dissolved in an ionic liquid, and the viscosity of the ionic liquid may then be tested. Typically a viscosity of less than 1000 mPa s, less than 500 mPa s, less than 100 mPa s, between and including 1 mPa s and 1000 mPa s, 1 mPa s and 500 mPa s, 1 mPa s and 100 mPa s. Viscosities are measured at 20° C. For batteries designed to function at substantially higher or lower temperatures (e.g. 5° C., 0° C., −5° C., 35° C., 40° C., 45° C.), viscosity measurements at those temperatures may be considered.

The ionic conductivity of an electrolyte based on the salt used and concentration thereof may also be determined to select a suitable salt and concentration. Ionic conductivities are within a range of between and including 6-16 mS/cm, or between and including 8-10 mS/cm. Alternatively, an effect of ionic conductivity may be measured by trying different salts and concentrations in otherwise identical batteries. Suitable effects of ionic conductivity that may be measured include columbic efficiency, battery impedance, rate capability and cycling behavior.

In particular examples, the salt may be LiN(FSO₂)₂, LiCF₃SO₃, LiN(CF₃SO₂)₂, LiN(CF₃CF₂SO₂)₂, or NaBF₄. The salt may be present in its ionic form. For example, LiCF₃SO₃ may be present as Li⁺ and CF₃SO₃⁻.

The positive electrode, such as positive electrode 60, in an alkali metal or alkaline earth metal rechargeable battery of the present disclosure, such as battery 50, includes an active material. The positive electrode may further include binders, conductive additives, and a current collector.

Suitable positive electrode active materials include lithium ion and sodium ion intercalation compounds and lithium or sodium reactive elements or compounds. Example positive electrode active materials include alkali metal or alkaline earth metal-transitions metal oxides, such as lithium transition metal oxides, for example lithium cobalt oxide (LiCoO₂), or lithium manganese oxide (LiMn₂O₄), alkali metal or alkaline earth metal-transition metal phosphates, sulfates, silicates, and vanadates, such as LiCoPO₄ and LiFePO₄, and alkali metal or alkaline earth metal-multi metal-oxides or phosphates, sulfates, silicates and vanadates, such as lithium nickel manganese cobalt oxide (LiNiMnCoO₂, often referred to as “NMC”), lithium nickel cobalt aluminum oxide (LiNiCoAlO₂).

Battery performance may be further increased if higher grade active materials resulting from enhanced manufacturing techniques are used in either the negative electrode or the positive electrode.

### Attritor-Mixed Positive Electrode Active Materials

Battery performance may be particularly good if positive electrode materials are manufactured using an attritor-mixing method. Such a method may be usable to produce commercial-level quantities of active material with no or low levels of impurities.

Methods of the present disclosure may be used to produce alkali metal or alkaline earth metal positive electrode active materials also including an electrochemically active metal and a tetraoxide polyanion, such as phosphate.

In particular, the positive electrode active materials may have a general chemical formula AₓM_{y}E_{z}(XO₄)_{q} and a crystal structure. A may be an alkali metal or an alkaline earth metal. M may be an electrochemically active metal. E may be located in the same structural location as A in the crystal structure and be a non-electrochemically active metal, a boron group element, or silicon (Si) or any alloys or combinations thereof. X may be part of the tetraoxide polyanion and may be phosphorus (P), sulfur (S) or silicon (S), or a combination thereof 0<x≤1, y>0, z≥0, q>0, and the relative values of x, y, z, and q are such that the general chemical formula is charge balanced.

The alkali metal (Group 1, Group I metal) in the active material may be lithium (Li) sodium (Na), or potassium (K). The alkaline earth metal (Group 2, Group IIA metal) may be magnesium (Mg) or calcium (Ca). The alkali metal or alkaline earth metal may be present as a mobile cation or able to form a mobile cation, such as lithium ion (Li⁺), sodium ion (Na⁺), potassium ion (K⁺, magnesium ion (Mg²⁺), or calcium ion (Ca²⁺).

The metal in the active material may be any electrochemically active metal, most commonly a transition metal, such as a Group 4-12 (also referred to as Groups IVB-VIII, IB and IIB) metal. Particularly useful transition metals include those that readily exist in more than one valence state. Examples include iron (Fe), chromium (Cr), manganese (Mn), nickel (Ni), cobalt (Co), vanadium (V), or titanium (Ti). The active material may include any electrochemically active combinations or alloys of these metals.

In addition, the active material may contain non-electrochemically active metals or a boron group element (Group 13, Group III), or silicon (Si), or any combinations or alloys thereof, which otherwise affect the electrical or electrochemical properties of the active material For example, non-electrochemically active metals or boron group element or silicon (Si) may change the operating voltage of the active material, or increase the electronic conductivity of active material particles, or improve the cycle life or coulombic efficiency of an electrochemical cell containing the active material. Suitable non-electrochemically active metals include alkaline earth metals (Group 2, Group II metals) such as magnesium (Mg), calcium (Ca) or strontium (Sr), or zinc (Zn), scandium (Sc), or lanthanum (La), or any alloys or combinations thereof. Suitable boron group elements include aluminum (Al) or gallium (Ga) and combinations thereof.

The tetraoxide polyanion may be phosphate (PO₄). Some active materials may contain other tetraoxide polyanions, such as sulfate (SO₄) in place of or in combination with phosphate. Some Si in the active material may be present in the form of silicate (SiO₄).

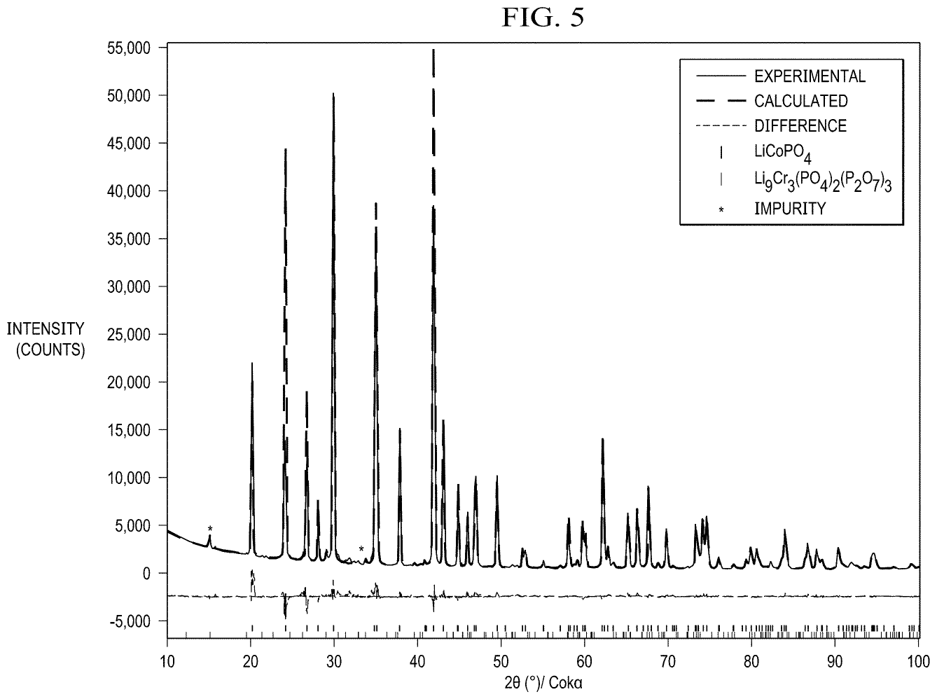

The alkali metal or alkaline earth metal, electrochemically active metal, non-electrochemically active metal or boron group element or silicon (Si), and tetraoxide polyanion are present in relative amounts so that the overall active material compound or mixture of compounds is charge balanced. The active material compound or mixture of compounds are primarily present in a crystalline, as opposed to an amorphous form, which may be confirmed via XRD. If the active material contains a mixture of compounds or a compound that may assume multiple crystal structures, the active material may exhibit more than one phase, with each phase having a different crystal structures. Common crystal structures for active materials produced using the methods described herein include olivine, NASICON, and orthorhombic structures. The presence of a given crystal structure as well as the identity of the active material compound producing that structure may be confirmed using XRD and reference XRD patterns correlating to known crystal structures. An example of such confirmation for Fe, Cr and Si-substituted LiCoPO₄ is provided in FIG. 5.

The active material may have the general chemical formula AₓM_{y}E_{z}(XO₄)_{q}, in which A is the alkali metal or alkaline earth metal, M is the electrochemically active metal, E is the non-electrochemically active metal or boron group element or Si or any alloys or combinations thereof, and X is phosphorus (P) or sulfur (S) or a combination thereof, q>0, and the relative values of x, y, z, and q are such that the general chemical formula is charge balanced.

In more specific examples, the active material may be a simple phosphate, such a lithium metal phosphate LiMPO₄, in which M is the electrochemically active metal. In particular, it may be LiFePO₄, LiMnPO₄ or LiCoPO₄. The active material may also be a more complex material, such as LiₓM_{y}E_{z}PO₄, where 0<x≤1, y>0, and z>0, M is the electrochemically active metal and E is a non-electrochemically active metal or a boron group element (Group 13, Group III), or Si. For example, the active material may be LiCo_{0.9}Fe_{0.1}PO₄, Li_{0.95}Co_{0.85}Fe_{0.1}Cr_{0.05}PO₄, Li_{0.93}Co_{0.84}Fe_{0.1}Cr_{0.05}Si_{0.01}PO₄, and LiCo_{0.82}Fe_{0.0976}Cr_{0.0488}Si_{0.00976}PO₄.

Active materials produced using the methods of the present disclosure may also have an integrally formed coating, such as a carbon coating or polymer coating. This integrally formed coating may be covalently bonded to the active material. Chemical formulas listed herein do not include coatings, even for active materials that are typically coated.

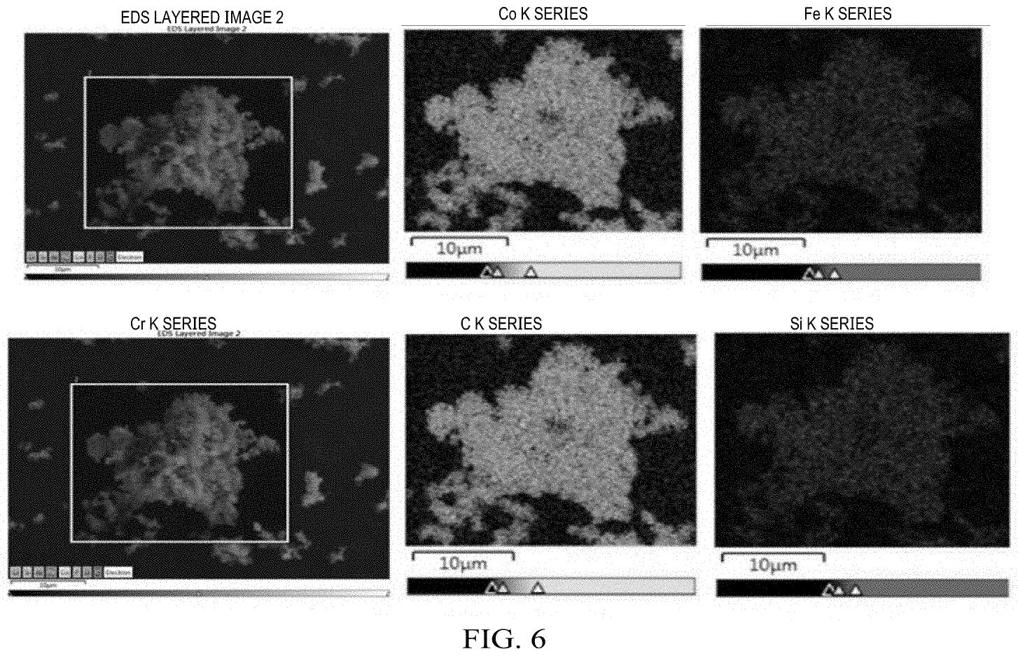

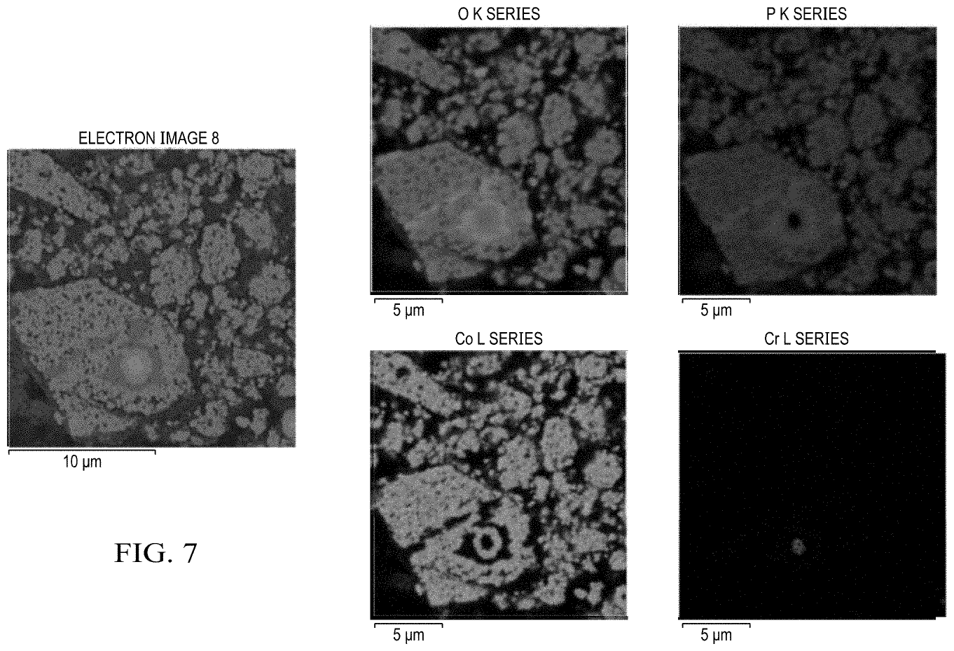

Active materials produced using the methods of the present disclosure may have a purity of at least 95%, at least 98%, at least 99%, or a purity in a range between and including any combinations of these values, as measured by XRD refinement, an example of which is provided in FIG. 5. Impurities are typically in the form of unreacted precursors or precursors that have reacted to form compounds other than the active material and crystalline impurities in amounts of 1% or greater of a given crystalline impurity compound may be detected using XRD. Non-crystalline impurities and impurities in amounts of less than 1% may be detected using EDX, examples of which are provided in FIG. 6 and FIG. 7.

Active materials formed using the methods disclosed herein, when used in an electrochemical cell, may exhibit stable capacity, with a capacity fade of 50% or less, 40% or less, 20% or less, 10% or less, 5% or less, 1% or less, or a range between and including any combinations of these values over 110 cycles at C/2 as compared to the capacity at the tenth cycle at C/2.

Active materials formed using the methods disclosed herein may be in the form of particles that are, on average over the batch of particles, excluding agglomerates, no longer than 1 nm, 10 nm, 50 nm, 100 nm, 500 nm, or 999 nm, or any range between and including any combination of these values. Such particles are referred to as nanoparticles. Active materials formed using the methods disclosed herein may be in the form of particles that are, on average over the batch of particles excluding agglomerates, no longer than 1 μm, 10 μm, 50 μm, 100 μm, 500 μm, or 999 μm, or any range between and including any combination of these values. Such particles are referred to as microparticles.

Active materials particle may form agglomerates, in which case any agglomerate is excluded from the average particle size discussed above. However, the agglomerate may itself be a nanoparticle or a microparticle. For example, the agglomerate may be a microparticle composed of nanoparticles of active material.

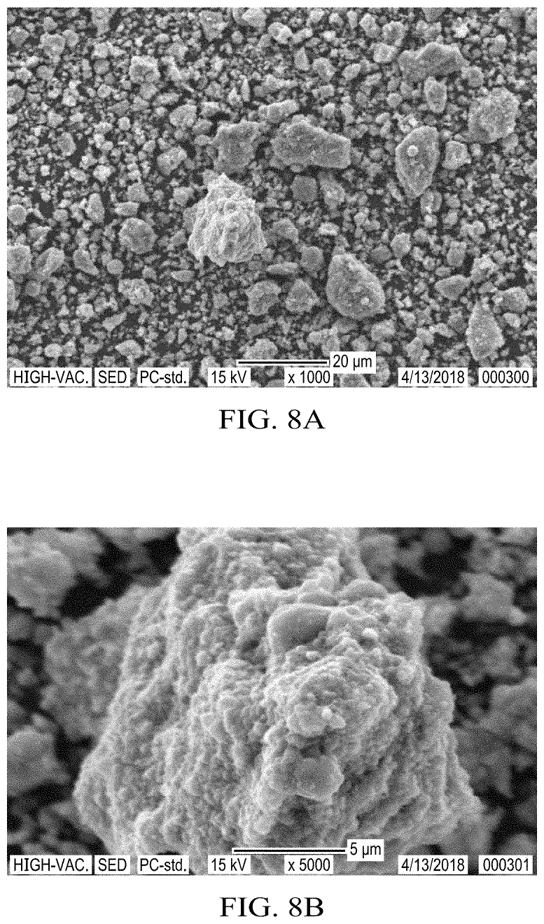

Particle and agglomerate size may be assessed using scanning electron microscopy (SEM), an example of which is shown in FIGS. 8A and 8B.

Suitable precursors for use in manufacturing the active material will depend on the specific active material to be produced. Typically the precursors are in solid form, as the methods disclosed herein are solid state manufacturing methods. Wet precursors or those available as hydrates or containing substantial humidity may be dried prior to use in the methods of the present disclosure. Common precursors include metal hydroxides, such as LiOH, Co(OH)₂ and Al(OH)₃, alkali metal phosphates, such as LiH₂PO₄ or Li₂HPO₄, alkaline earth metal phosphates, non-metal phosphates, such as NH₄H₂PO₄, (NH₄)₂HPO₄, metal oxides, such as Cr₂O₃, CaO, MgO, SrO, Al₂O₃, Ga₂O₃, TiO₂, ZnO, Sc₂O₃, La₂O₃ or ZrO₂, acetates, such as Si(OOCCH₃)₄, and oxalates, such as FeC₂O₄, NiC₂O₄ or CoC₂O₄, (which are often stored as a hydrate, which may be dried before use in the present methods), or carbonates, such as Li₂CO₃, MnCO₃, CoCO₃ or NiCO₃.

For active materials that have a coating, such as a carbon coating, coating precursors may also be included in the methods described herein. Suitable coating precursors include elemental carbon or carbon-containing materials, such as polymers, that are broken down to form a carbon coating. Suitable coating precursors may also include coating polymers, or monomers or oligomers that form larger coating polymers.

Active materials, including those described above may be manufactured from precursors, including those described above. The methods are solid-state methods that generally include attritor-mixing of at least non-coating precursors, followed by heating the mixture.

Methods disclosed herein may be used to form at least 1 kg, at least 2 kg, at least 3 kg, at least 5 kg, at least 10 kg, at least 25 kg, at least 50 kg, at least 100 kg active material, or an amount between and including any two of these recited amounts (e.g. between and including 1 kg and 2 kg, between and including 1 kg and 3 kg, between and including 1 kg and 5 kg, between and including 1 kg and 10 kg, between 1 kg and 50 kg, between and including 1 kg and 50 kg, between and including 1 kg and 100 kg, between 25 kg and 50 kg) per batch.

Methods disclosed herein, prior to particle size filtering, may have a yield of at least 80%, at least 85%, or at least 90%, at least 95%, or at least 99%, at least 99.9% or an amount between and including any two of these recited amounts per batch. Yield is measured prior to particle size filtering to exclude effects directly to the particle size selected, rather than the active-particle forming reaction and method.

For coated active materials, the coating precursor may be added prior to attritor-mixing, after attritor-mixing, but before heating, or after heating, depending largely on the coating to be formed. For example, carbon coating precursors will typically be added prior to attritor-mixing. Polymer coating precursors will typically be added after heating. For simplicity, the method as described below does not include a description of coating precursors or when they are added to the process, nor does it include details of how the coating is formed. One of ordinary skill in the art, using the teachings of the present disclosure and, optionally, through conducting a series of simple experiments in which coating materials are added at different stages of the methods, also optionally in different relative amounts, will be able to readily determine how to incorporate coating steps into the methods disclosed herein.

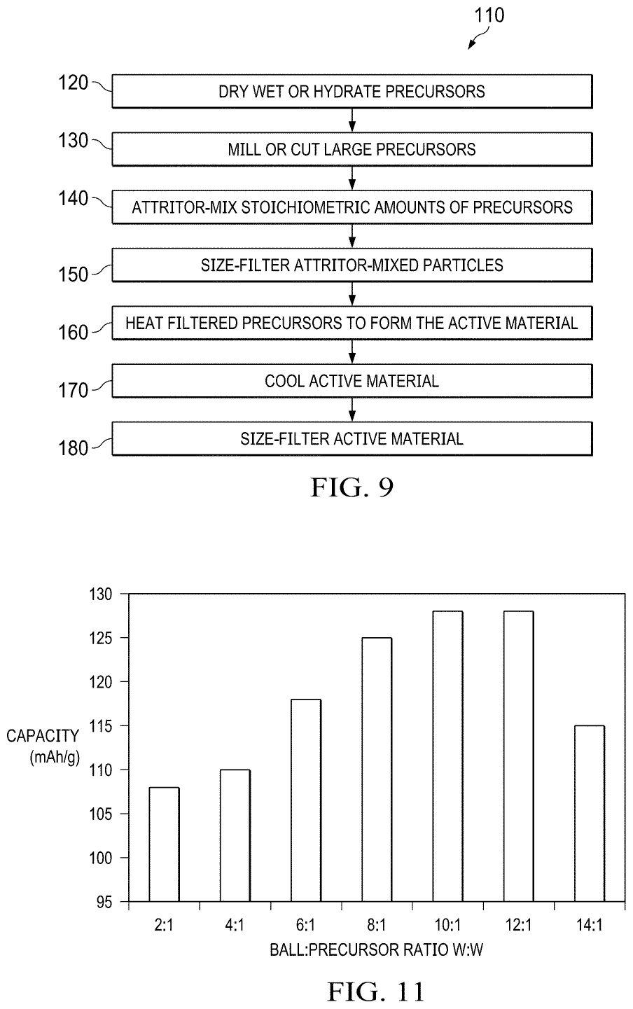

Referring now to FIG. 9, the present disclosure provides a method 110 for manufacturing an active material. In step 120, wet or hydrate precursors are dried. In step 130, precursors that are too large to fit in the attritor chamber or to be milled by the attritor are cut to a sufficiently small size. Steps 120 and 130 may be performed in any order.

In step 140, stoichiometric amounts of precursors that will be attritor-mixed are placed in the chamber of the attritor and attritor-mixed to form precursor particles. Although, typically, all active material precursors will be attritor-mixed, some precursors may be added after attritor-mixing.

The attritor used in step 140 may be any suitable attritor. An attritor is a mixing apparatus having a container, an arm extending from the exterior of the container through a lid of the container and into the interior of the container, and at least one and typically a plurality of paddles in the interior of the container coupled to the arm so that when the arm rotates in response to a rotational force applied outside of the container, the paddles rotate within the container. If a material is in the container, then it will be impacted by the paddles and its size will be reduced by a combination of friction and impact with the paddles or other materials in the container.

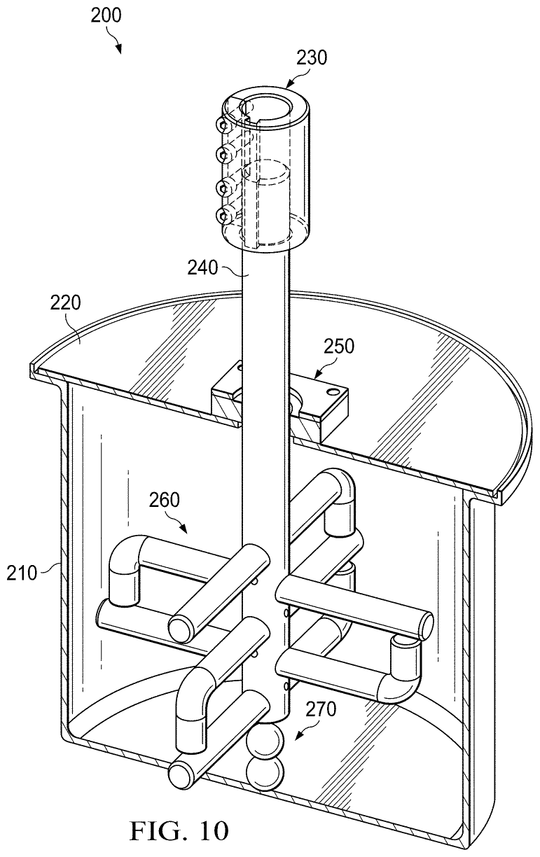

An example attritor 200 suitable for use in methods of the present disclosure is depicted in FIG. 10. Attritor 200 includes a container 210, which has a lid 220. Attritor 200 also includes couple 230, which attaches to an external source of rotational force, such as a motor. Couple 230 is located at a first end of an arm 240, which is located exterior to the container 210. The arm 240 passes through a guide 250 mounted on the lid 220 and through the lid 220 into the interior of the container 210. At least one and, as depicted, typically a plurality of paddles 260 are located in the interior of the container 210 and are coupled to a portion of the arm 240 also in the interior of the container 210.

The attritor 200 also includes a plurality of balls 270 (depicted as only two balls for simplicity).

During operation of the attritor, the balls are also impacted by the paddles and/or the material and help reduce the size of the precursors.

Balls used in step 140 may be of any size suitable to reduce the precursors to a set particle size within a set time. 19 mm diameter balls may work particularly well, and 12.7 mm diameter balls may also be suitable.

The balls may be made of any materials that do not react with the precursors to a degree that reduces yield below 80% or produces impurities in an amount of more than 5% total impurities. Suitable materials for the balls include steel, zirconium, or tungsten. The balls may have an interior made of a different material with an exterior coating of a suitable material.

Although the balls contribute to reduction of precursor size, they also occupy volume in the attritor chamber that might otherwise be occupied by precursors. Accordingly, the proportion of balls to total precursors (w:w) may be limited to the smallest ratio that still allows an active material having the selected particle size or other set property to result from the overall method 110. For example, FIG. 11 shows a comparison of capacity and ball:total precursors (w:w) such as might be used to select the proportion.

The particle size of precursors after attritor-mixing is typically 10 μm or less, 50 μm or less, 100 μm or less, 500 μm or less, 600 μm or less, or 750 μm or less and any ranges between and including and combinations of these values, (e.g. between and including 1 μm and 10 μm, between and including 1 μm and 50 μm, between and including 10 μm and 50 μm, between and including 1 μm and 600 μm). An appropriate w:w ratio may vary depending on the precursors used, the size of the precursors prior to attritor mixing, the size of the balls, and the attritor used, but one of ordinary skill in the art, using the teachings of this disclosure, may readily determine the appropriate ball:precursor ratio by simply varying these parameters until an acceptable precursor particle size or other set property such as capacity is obtained.

The total volume of balls and precursors in the attritor should not have a volume exceeding that specified by the attritor manufacturer. Typically, the total volume of balls and precursors is no more than 75% of the total volume of the attritor container, to allow sufficient room for the balls and precursors to move during mixing.

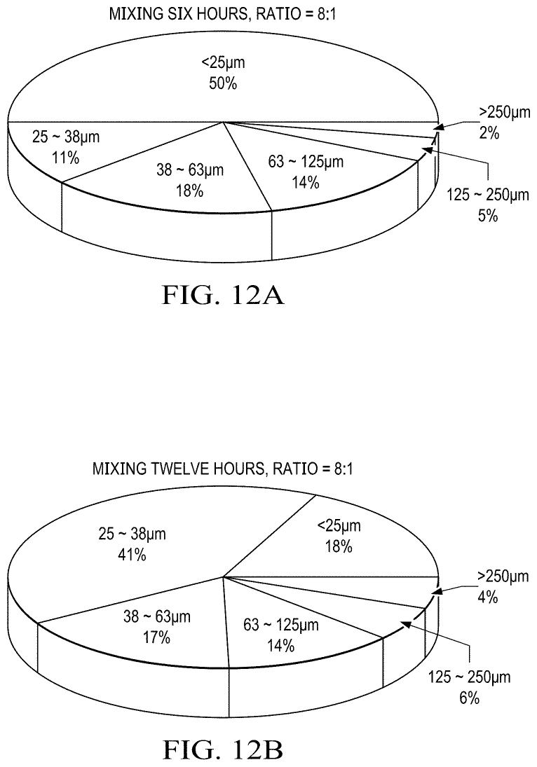

For any given set of precursors (at a selected pre-attritor-mixing size), ball:precursor ratio, ball size, and attritor, there will be a reduction of average precursor particle size over time during attritor-mixing until a particle size plateau is reached. Once the particle size plateau is reached, any additional duration of attritor-mixing will not further reduce the average precursor particle size by more than 10%, as compared to the average precursor particle size at the duration of time when the particle size plateau is reached. The plateau may also readily be determined by one of ordinary skill in the art, using the teachings of this disclosure. Although attritor-mixing in step 140 may be continued after the particle size plateau is reached, typically step 140 will last only until the particle size plateau is reached, no more than 10% longer than the duration at which the particle size plateau is reached, or a duration between and including these two times. Common mixing times to reach plateau include 10-12 hours. Examples particle size distributions based on mixing duration that may be used to determine when plateau is reached are provided in FIG. 12A and FIG. 12B.

Properties, such as yield or active material capacity, determined at least in part by particle size may also exhibit a plateau with respect to attritor-mixing duration and attritor-mixing duration may be set based on such an alternative plateau such that the attritor-mixing duration is only until the plateau is reached, no more than 10% longer than the duration at which the plateau is reached, or a duration between and including these two times.

In some methods, it may be useful to control the temperature within the attritor during attritor-mixing. For example, some precursors may be temperature-sensitive, or it may be useful to limit reaction of the precursors to for the active material during attritor-mixing. If useful, the attritor may further contain a cooling system, such as an exterior cooling system or a cooling system located within the container, lid, arm, paddles, or any combinations of these. The cooling system may keep the temperature below a set temperature during step 140. Alternatively, or in addition, the precursors may be cooled prior to attritor-mixing in step 140. Also alternatively, or in addition, the attritor may include a thermometer to allow a ready determination of whether the precursors exceeded a set temperature during step 140, in which case they may be discarded or subjected to a quality control process.

After attritor-mixing in step 140, a stoichiometric amount of any precursors not subjected to attritor-mixing is added to the attritor-mixed precursor particles.

Next, in step 150, the attritor-mixed precursor particles are filtered to exclude particles above a set size, typically 10 μm, 50 μm, or 100 μm.

The filtered precursors are then heated in step 160 for a duration of time to undergo a chemical reaction and form the active material. The temperature to which the precursors are heated may vary depending on the precursors and active material. The heating in step 50 may be a simple heating process, in which the precursors are heated to a set temperature and maintained at that temperature for the duration of time. The heating in step 160 may also be a more complicated, stepped process, in which the precursors are heated to one or more temperatures for one or more times. The rate at which heating in step 160 occurs may also be controlled to occur at a particular degrees per minute and step 160 may even include cooling followed by heating in the overall heating process.

For active materials containing lithium, cobalt, and phosphate, the maximum temperature in heating step 160 may be at least 600° C., particularly between and including 600° C. and 800° C., and may be attained through temperature increases of between 1° C./min and 10° C./min. The heating step may last for at least 6 hours, at least 8 hours, at least 10 hours, or at least 12 hours, at least 18 hours, least 24 hours and ranges between and including and combinations of these values particularly between and including 6 hours and 24 hours. Heating may occur under a reducing or inert atmosphere, such as a nitrogen (N₂) atmosphere. Heating may be preceded by a purge at room temperature (25° C.) under a reducing or inert atmosphere, such as a nitrogen atmosphere, for 1-4 hours, typically 3 hours.

After heating, in step 170 the material is cooled. Cooling may be a simple, passive cooling process, an active cooling process, or a stepped process. The material may be maintained a particular temperatures for a duration of time. The rate at which cooling occurs may also be controlled to occur at a particular degrees per minute and step 170 may even include heating followed by cooling in the overall cooling process.

The active material is present by the end of the cooling process 170. Depending on the precursors and active material, the active material may often be present even at the end of heating in step 160. In some methods 110, the heating process 510 and the cooling process 170 may overlap to form one continuous heating/cooling process.

Finally, in step 180, the active material is filtered to exclude particles above a set size. For example, 25 μm, 35 μm, 38 μm, 40 μm, 50 μm, or 100 μm.

It will be understood that methods of the present disclosure may practice only steps 140 and 160 (or step 160/170 in place of step 160 if heating and cooling form one continuous heating/cooling process). The other steps described in connection with method 110 are each independently omittable.

All or part of the steps of method 110 may be carried out in conditions that limit humidity. For example, all or part of the steps of method 110 may be carried out in a dry room or in a water-exclusive atmosphere, such as an inert, hydrogen, or nitrogen atmosphere (although, for most active materials, this degree of precaution is not needed), or at ambient humidity of less than 25% or less than 10%.

Active materials produced using the above method may be used in the positive electrodes of batteries, such as the battery 50 illustrated in FIGS. 1-4.

### Uses of Batteries

Batteries disclosed herein can be used in many applications. For example, they may be standard cell format batteries, such as coin-type cells, cylindrical-type cells, or pouch-type prismatic cells. Batteries disclosed herein may be used in portable consumer electronics, such as laptops, phones, notebooks, handheld gaming systems, electronic toys, watches, and fitness trackers. Batteries disclosed herein may also be used in medical devices, such as defibrillators, heart monitors, fetal monitors, and medical carts. Batteries disclosed herein may be used in vehicles, such as cars, light trucks, heavy trucks, vans, motorcycles, mopeds, battery-assisted bicycles, scooters, boats and ships, piloted aircraft, drone aircraft, military land transports, and radio-controlled vehicles. Batteries disclosed herein may also be used in grid storage or large scale energy supply applications, such as large grid storage units or portable energy supply containers. Batteries disclosed herein may be used in tools, such as handheld power tools.

Batteries disclosed herein may be connected in series or in parallel and may be used in connection with control or monitoring equipment, such as voltage, charge, or temperature monitors, fire suppression equipment, and computers programmed to control battery usage or trigger alerts or safety measures if battery conditions may be unsafe.

### EXAMPLES

The following examples are provided solely to illustrate certain principles associated with the invention. They are not intended to nor should they be interpreted as disclosing or encompassing the entire breath of the invention or any embodiments thereof.

### Example 1

### Pouch-Type Cell With External Pressure

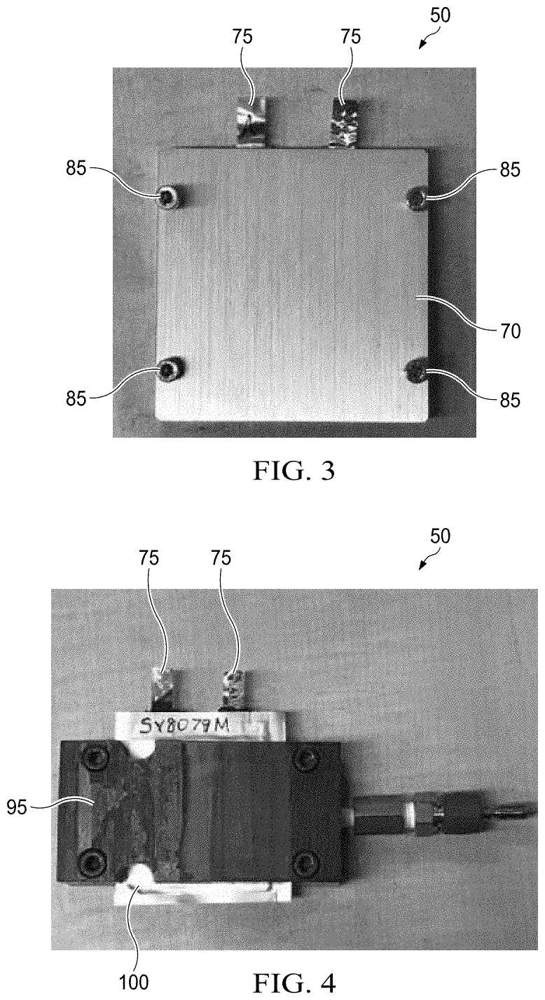

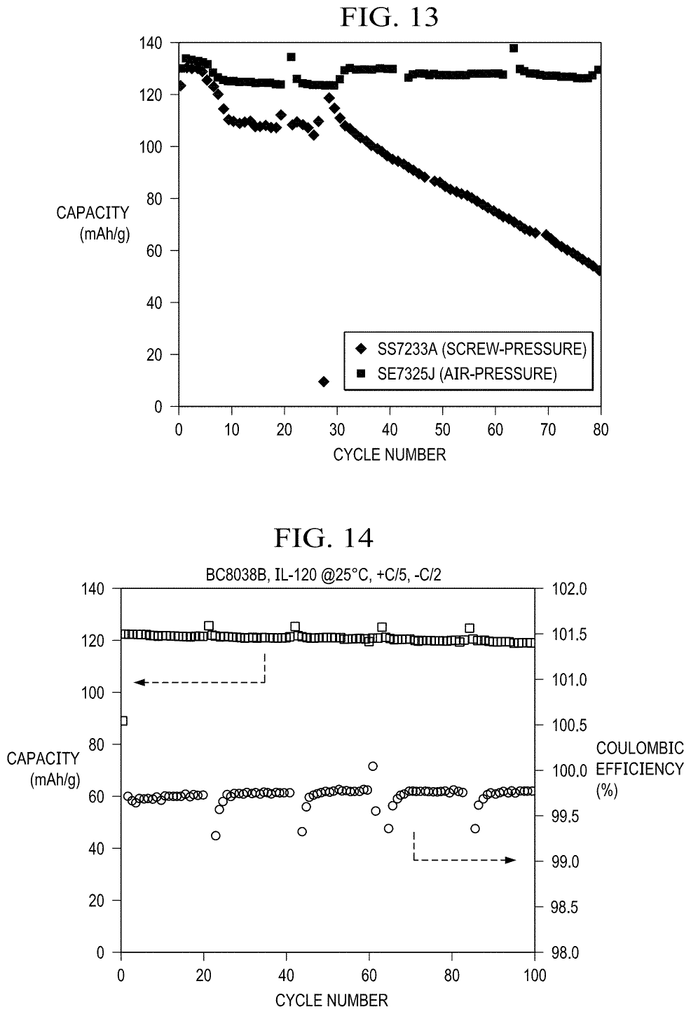

LiCo_{0.82}Fe_{0.0976}Cr_{0.0488}Si_{0.00976}PO₄ was synthesized using an attritor-mixing method as disclosed herein. To form the positive electrode, 90 wt % of LiCo_{0.82}Fe_{0.0976}Cr_{0.0488}Si_{0.00976}PO₄, 5 wt % of polyvinylidene fluoride (PVdF) and 5 wt % of conductive carbon were mixed in N-Methyl-2-pyrrolidone solution and then coated on Al-foil. To form the negative electrode, 94 wt % of graphite, 5 wt % of PVdF and 1 wt % of conductive carbon were mixed in N-Methyl-2-pyrrolidone solution and then coated on Cu-foil. To form the electrolyte, LiN(FSO₂)₂ (or LiF₂NO₄S₂) (LiFSI) was dissolved into N-methyl-N-propylpyrrolidinium-bis(fluorsulfonyl)imide (Py13-FSI) at a concentration of 1.2 mol/L. A pouch-type cell was assembled in a dry room. Screw-pressure (as shown in FIG. 3) and air-pressure (as shown in FIG. 4) were applied separately on the pouch-type cells. The cycling stability of the pouch-type cell with screw-pressure and air-pressure was compared at 25° C. and results are presented in FIG. 13.

### Example 2

### Coin-Type Cell With Ionic Liquid Electrolyte

Electrodes and electrolyte were prepared as in Example 1. A coin-type cell was assembled in an argon (Ar)-filled glove box. FIG. 14 shows the typical cycling stability and columbic efficiency of the coin-type cell at 25° C. 120 mAh/g of reversible capacity was obtained and over 97% capacity was retained after 100 cycles at C/2 rate.

### Example 3

### GEN1 Pouch-Type Cell With Ionic Liquid Electrolyte

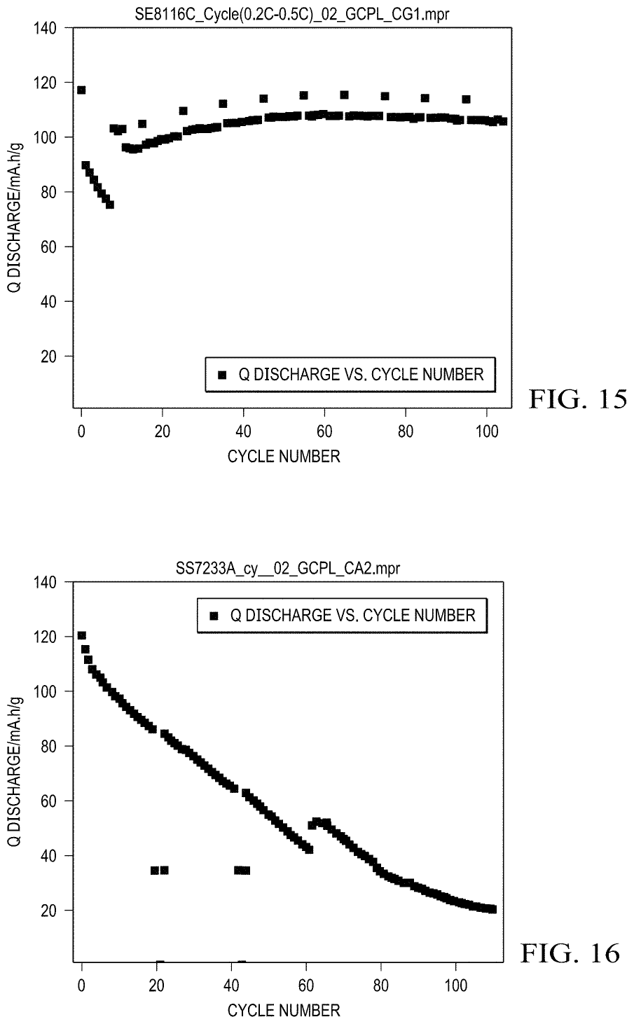

Electrodes and electrolyte were prepared as in Example 1. A 32 mAh pouch-type cell was assembled in a dry-room. FIG. 15 shows the typical cycling stability of this 32 mAh pouch-type cell at 25° C. 105 mAh/g of reversible capacity was obtained and over 98% capacity was retained after 100 cycles at C/2 rate.

### Comparative Example for Example 3

Electrodes were prepared as in Example 1. An electrolyte containing 1.2 mol/L LiPF6 in EC/EMC was prepared and used instead of ionic liquid. A 32 mAh pouch-type cell was assembled in a dry-room. FIG. 16 shows the typical cycling stability of this 32 mAh pouch-type cell at 25° C. with EC-based electrolyte. 120 mAh/g of capacity was obtained at the first cycle but only 17% capacity was retained after 100 cycles at C/2 rate.

### Example 4

### GEN2 Pouch-Type Cell With Ionic Liquid Electrolyte

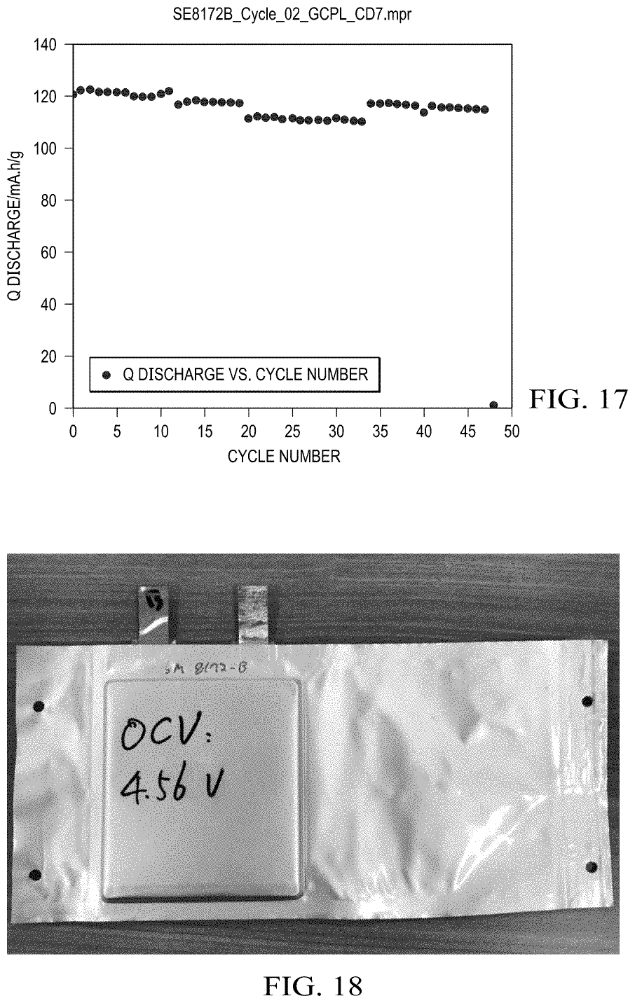

Electrodes and electrolyte were prepared as in Example 1. A 1.2 Ah pouch-type cell was assembled in a dry-room. FIG. 17 shows the typical cycling stability of this 1.2 Ah pouch-type cell at 25° C. 120 mAh/g of reversible capacity was obtained and about 93% capacity was retained after 47 cycles at C/2 rate. FIG. 18 is a photograph of this 1.2 Ah pouch-type cell after 47 cycles at C/2 rate. No obvious gas generation was observed.

### Comparative Example for Example 4

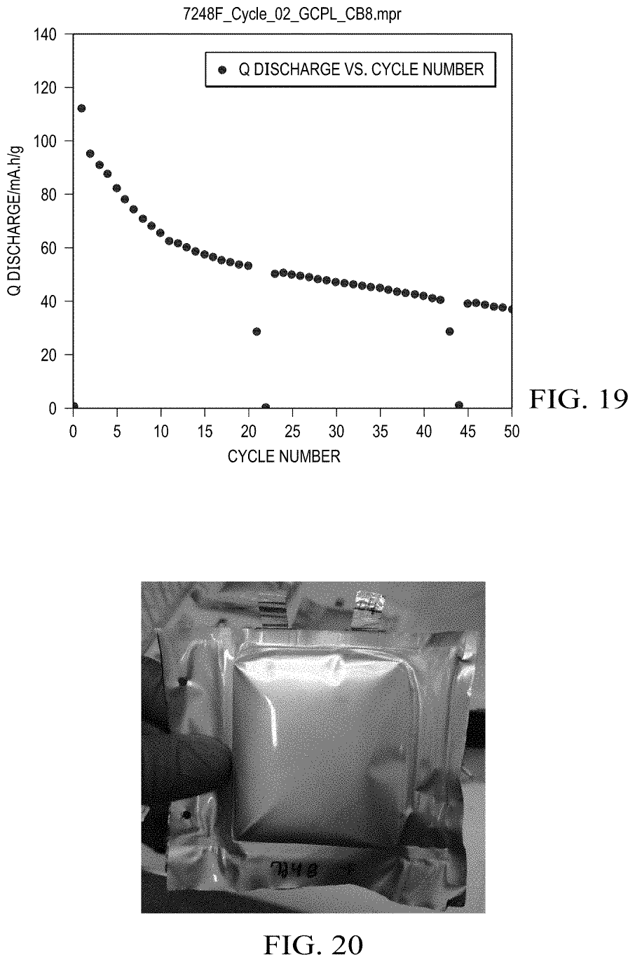

Electrodes were prepared as in Example 1. An electrolyte containing 1.2 mol/L LiPF6 in EC/EMC was prepared and used instead of ionic liquid. A 1.2 Ah pouch-type cell was assembled in a dry-room. FIG. 19 shows typical cycling stability of this 1.2 Ah pouch-type cell at 25° C. with EC-based electrolyte. 118 mAh/g of capacity was obtained at the first cycle but only 33% capacity was retained after 50 cycles at C/2 rate. FIG. 20 is a photograph of this 1.2 Ah pouch-type cell after 50 cycles at C/2 rate. Substantial gas generation was observed.

### Example 5

### Attritor-Mixed LiCo_{0.82}Fe_{0.0976}Cr_{0.0488}Si_{0.00976}PO₄ (6:1 Ratio)

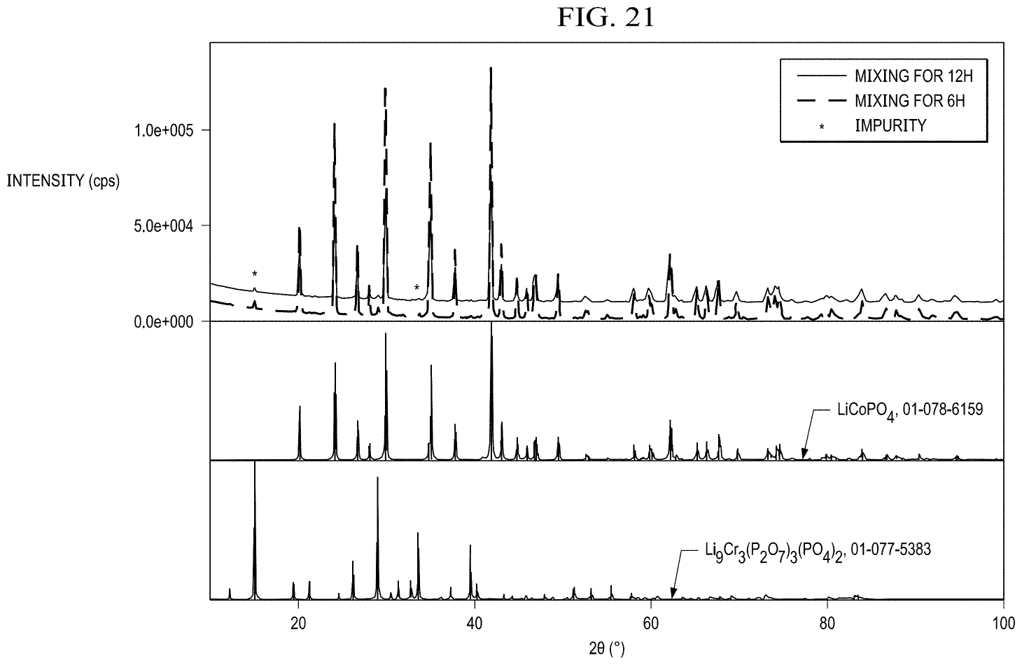

930 g of LiH₂PO₄, 675 g of Co(OH)₂, 160 g of FeC₂O₄.2H₂O, 28.5 g of Cr₂O₃, 23 g of Si(OOCCH₃)₄, and 76.3 g of acetylene black having dimensions of less than 500 μm were pre-dried at 120° C. overnight under vacuum and then placed in an attritor having container volume of 9.5 L, 11.3 kg of steel balls (6:1 ball:precursor w:w ratio) with diameter of 19 mm were added. The attritor was operated at 400 rpm for 6-12 hours. Attritor-mixed precursors were transferred to an oven then heated to 700° C. for 12 hours under N₂ and naturally cooled in the oven. After heat treatment, about 1.4 kg of final product was obtained and then filtered through a 38 μm sieve. XRD analysis of the resulting material is presented in FIG. 21. The XRD data confirm that active material having the same structure as LiCoPO₄ was produced even after only 6 hours of mixing.

### Example 6

### Attritor-Mixed LiCo_{0.82}Fe_{0.0976}Cr_{0.0488}Si_{0.00976}PO₄ (8:1 ratio)

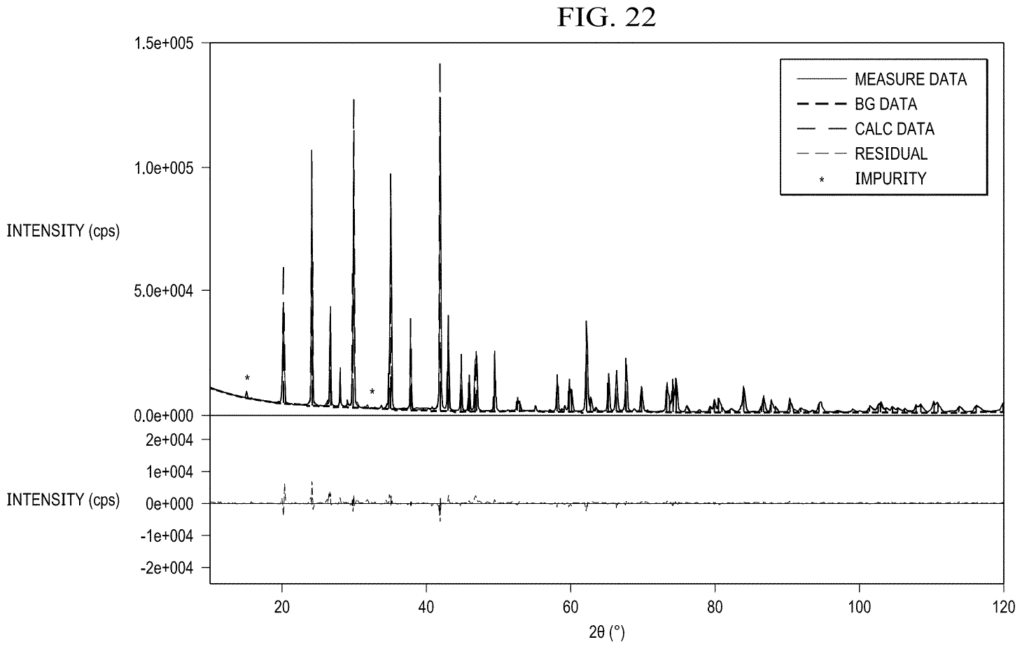

723 g of LiH₂PO₄, 525 g of Co(OH)₂, 122 g of FeC₂O₄.2H₂O, 22.2 g of Cr₂O₃, 17.9 g of Si(OOCCH₃)₄, and 59.4 g of acetylene black having dimensions of less than 500 μm were firstly pre-dried at 120° C. overnight under vacuum and then placed in an attritor having container volume of 9.5 L, 11.8 kg of steel balls (8:1 ball:precursor w:w ratio) with diameter of 19 mm were added. The attritor was operated at 400 rpm for 12 hours. Attritor-mixed precursors were transferred to an oven then heated to 700° C. for 12 hours under N₂ and naturally cooled in the oven. After heat treatment, about 1.1 kg of final product was obtained and then filtered through a 38 μm sieve. XRD analysis of the resulting material is presented in FIG. 22. The XRD data confirm that active material having the same structure as LiCoPO₄ was produced.

### Example 7

### Attritor-Mixed LiCo_{0.82}Fe_{0.0976}Cr_{0.0488}Si_{0.00976}PO₄ (10:1 ratio)

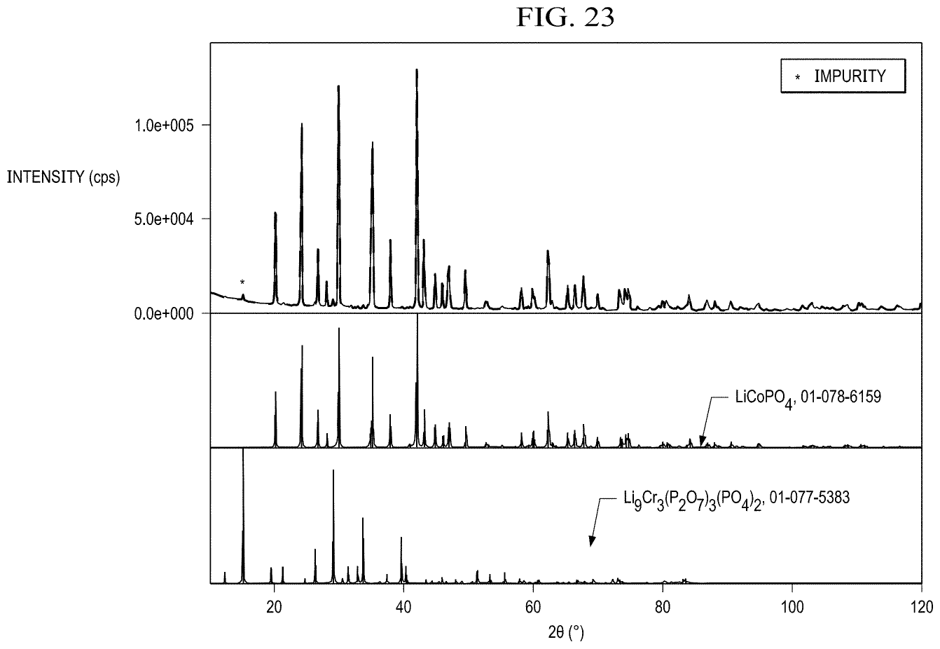

578 g of LiH₂PO₄, 420 g of Co(OH)₂, 97.6 g of FeC₂O₄.2H₂O, 17.7 g of Cr₂O₃, 14.3 g of Si(OOCCH₃)₄, and 47.5 g of acetylene black having dimensions of less than 500 μm were firstly pre-dried at 120° C. overnight under vacuum and then placed in an attritor having container volume of 9.5 L, 11.8 kg of steel balls (10:1 ball:precursor w:w ratio) with diameter of 19 mm were added. The attritor was operated at 400 rpm for 12 hours. Attritor-mixed precursors were transferred to an oven then heated to 700° C. for 12 hours under N₂ and naturally cooled in the oven. After heat treatment, about 0.9 kg of final product was obtained and then filtered through a 38 μm sieve. XRD analysis of the resulting material is presented in FIG. 23. The XRD data confirm that active material having the same structure as LiCoPO₄ produced.

### Example 8

### Attritor-Mixed LiCo_{0.82}Fe_{0.0976}Cr_{0.0488}Si_{0.00976}PO₄ (12:1 ratio)

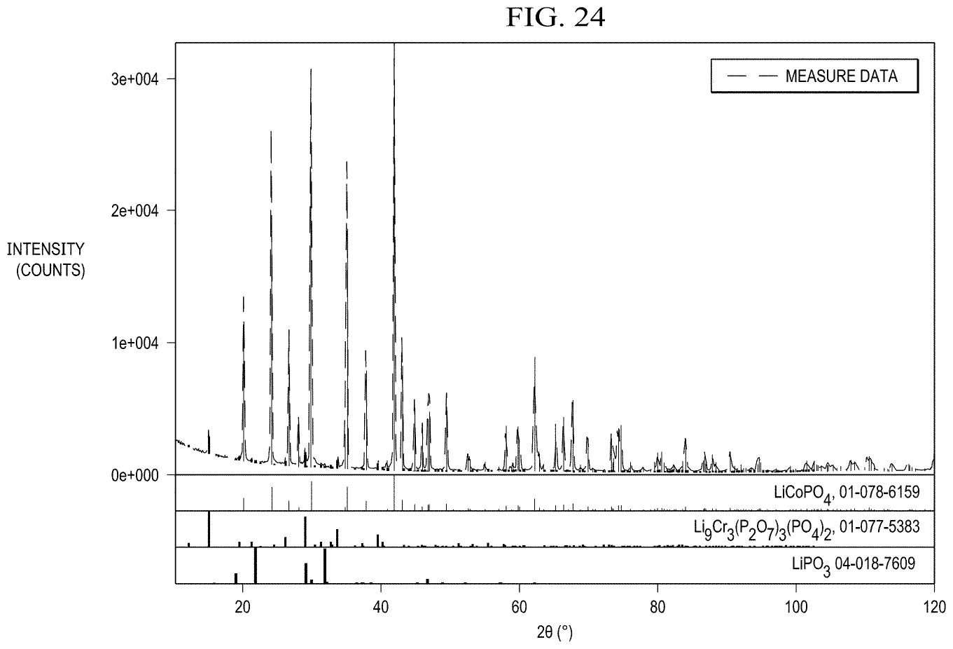

483 g of LiH₂PO₄, 351 g of Co(OH)₂, 81.5 g of FeC₂O₄.2H₂O, 14.8 g of Cr₂O₃, 12.0 g of Si(OOCCH₃)₄, and 39.8 g of acetylene black having dimensions of less than 500 μm were firstly pre-dried at 120° C. overnight under vacuum and then placed in an attritor having container volume of 9.5 L, 11.8 kg of steel balls (12:1 ball:precursor w:w ratio) with diameter of 19 mm were added. The attritor was operated at 400 rpm for 12 hours. Attritor-mixed precursors were transferred to an oven then heated to 700° C. for 12 hours under N₂ and naturally cooled in the oven. After heat treatment, about 0.73 kg of final product was obtained and then filtered through a 38 μm sieve. XRD analysis of the resulting material is presented in FIG. 24. The XRD data confirm that active material having the same structure as LiCoPO₄ was produced.

### Example 9

### Attritor-Mixed LiCo_{0.82}Fe_{0.0976}Cr_{0.0488}Si_{0.00976}PO₄ (14:1 ratio)

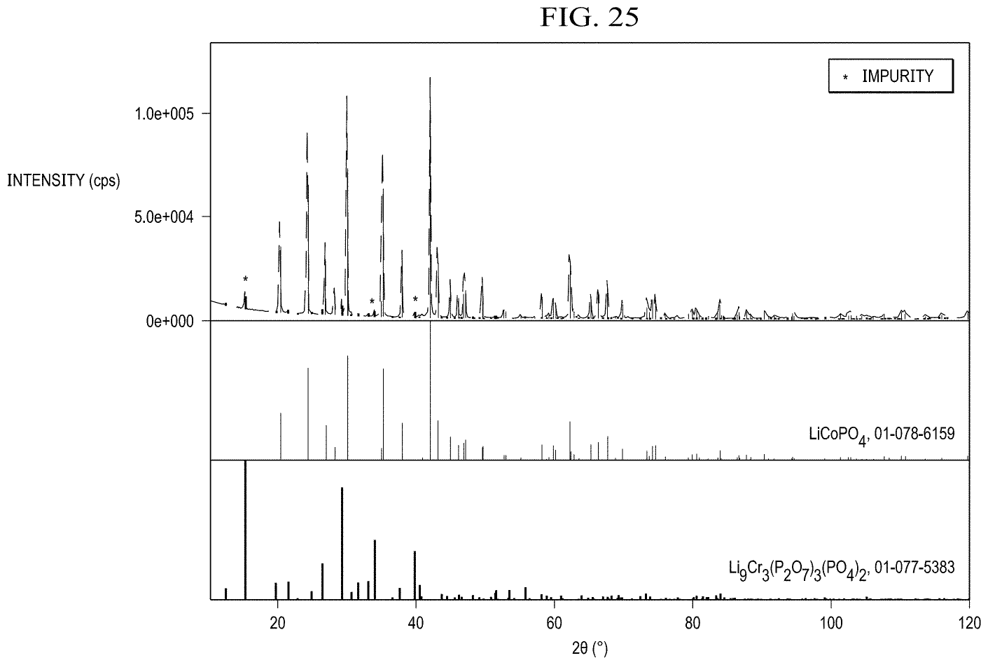

413 g of LiH₂PO₄, 301 g of Co(OH)₂, 70 g of FeC₂O₄.2H₂O, 12.7 g of Cr₂O₃, 10.3 g of Si(OOCCH₃)₄, and 34 g of acetylene black having dimensions of less than 500 μm were firstly pre-dried at 120° C. overnight under vacuum and then placed in an attritor having container volume of 9.5 L, 11.8 kg of steel balls (14:1 ball:precursor w:w ratio) with diameter of 19 mm were added. The attritor was operated at 400 rpm for 12 hours. Attritor-mixed precursors were transferred to an oven then heated to 700° C. for 12 hours under N₂ and naturally cooled in the oven. After heat treatment, about 0.62 kg of final product was obtained and then filtered through a 38 μm sieve. XRD analysis of the resulting material is presented in FIG. 25. The XRD data confirm that active material having the same structure of LiCoPO₄ was produced.

The above disclosed subject matter is to be considered illustrative, and not restrictive, and the appended claims are intended to cover all such modifications, enhancements, and other embodiments which fall within the true spirit and scope of the present disclosure. For example, although a simple battery including one negative electrode and one positive electrode is described, it is well within the abilities of one or ordinary skill in the art, using the disclosure contained herein, to construct a battery, such as a coin cell, containing multiple electrodes. Thus, to the maximum extent allowed by law, the scope of the present disclosure is to be determined by the broadest permissible interpretation of the following claims and their equivalents, and shall not be restricted or limited by the foregoing detailed description.

1. An alkali metal or alkaline earth metal rechargeable battery comprising:
an electrolyte comprising an ionic liquid and an alkali metal salt or alkaline earth metal salt;
a negative electrode comprising a surface that contacts the electrolyte, the negative electrode comprising a negative electrode active material;
a positive electrode comprising a surface that contacts the electrolyte, the positive electrode comprising a positive electrode active material;
an electronically insulative separator between the positive electrode and the negative electrode;
a casing surrounding the electrolyte, electrodes, and separator; and
a pressure application system operable to apply pressure to at least a portion of the electrode surfaces contacting the electrolyte.

2. The battery of claim 1, wherein the pressure application system comprises a seal internal to the battery and a pressure application structure.

3. The battery of claim 2, wherein the pressure application structure comprises plates and a clamp or screw.

4. The battery of claim 2, wherein the pressure application structure comprises a pressure bladder.

5. The battery of claim 1, further comprising a gas relocation area.

6. The battery of claim 1, wherein the pressure application structure applies pressure to at least 90% the surfaces of the electrodes contacting the electrolyte.

7. The battery of claim 1, wherein pressure applied by the pressure application structure does not vary by more than 5% between any points where the pressure is applied.

8. The battery of claim 1, wherein the pressure applied by the pressure application structure is between 50 psi and 90 psi.

9. The battery of claim 1, wherein the battery exhibits a capacity fade of between 1% and 50% over 110 cycles at C/2 as compared to the capacity at the tenth cycle at C/2.

10. The battery of claim 1, wherein the battery exhibits a capacity fade of between 50% and 1% over 110 cycles at C/2 as compared to the capacity at the tenth cycle at C/2 as compared to an otherwise identical battery lacking a pressure application system.

11. The battery of claim 1, wherein a cationic component of the ionic liquid comprises a nitrogen (N)-based ionic liquid.

12. The battery of claim 11, wherein the N-based ionic liquid comprises an ammonium ionic liquid, an imidazolium ionic liquid, a piperidinium ionic liquid, a pyrrolidinium ionic liquid, or any combinations thereof.

13. The battery of claim 12, wherein the N-based ionic liquid comprises N,N-diethyl-N-methyl-N-(2-methoxyethyl) ammonium, ethyl methyl imidazolium (EMIm), methyl propyl imidazolium, (PMIm), butyl methyl imidazolium (BMIm), 1-ethyl-2,3-dimethylimidazolium, ethyl methyl piperidinium (EMPip), methyl propyl piperidinium (PMPip), butyl methyl piperidinium (BMPip), ethyl methyl pyrrolidinium (EMPyr), methyl propyl pyrrolidinium (PMPyr), butyl methyl pyrrolidinium (BMPyr), or any combinations thereof.

14. The battery of claim 1, wherein cationic component of the ionic liquid comprises a phosphorus (P)-based ionic liquid.

15. The battery of claim 14, wherein the P-based ionic liquid comprises a phosphonium ionic liquid.

16. The battery of claim 15, wherein the phosphonium ionic liquid comprises PR₃R′ phosphonium, wherein R is methyl, ethyl, butyl, hexyl, or cyclohexyl, and R′ is methyl or butyl ((CH₂)₃CH₃).

17. The battery of claim 1, wherein the alkali metal salt comprises LiN(FSO₂)₂ (LiFSI), LiCF₃SO₃, LiN(CF₃SO₂)₂ (LiTFSI), LiN(CF₃CF₂SO₂)₂ (LiBETI), or NaBF₄, or any combinations thereof.

18. The battery of claim 1, wherein the negative electrode active material comprises metal, carbon, a lithium or sodium titanate or niobiate, or a lithium or sodium alloy.

19. The battery of claim 1, wherein the positive electrode active material comprises a lithium transition metal oxide, an alkali metal or alkaline earth metal-transition metal phosphate, sulfate, silicate, or vanadate, or alkali metal or alkaline earth metal-multi metal-oxides or phosphates, sulfates, silicates, or vanadates.

20. The battery of claim 1, wherein the positive electrode active material comprises an attritor-mixed active material having the general chemical formula AₓM_{y}E_{z}(XO₄)_{q} and a crystal structure, wherein A is an alkali metal or an alkaline earth metal, M is an electrochemically active metal, E is located in the same structural location as A in the crystal structure and is a non-electrochemically active metal, a boron group element, or silicon (Si) or any alloys or combinations thereof, X is phosphorus (P) or sulfur (S) or a combination thereof, 0<x≤1, y>0, z≥0, q>0, and the relative values of x, y, z, and q are such that the general chemical formula is charge balanced.
